(19) United States
(12) Patent Application Publication
(10) Pub. No.: US 2014/0118460 A1
(43) Pub. Date: May 1, 2014

(54) Video Coding

(71) Applicant: MICROSOFT CORPORATION, Redmond, WA (US)

(72) Inventors: Lazar Bivolarsky, Cupertino, CA (US); Soren Vang Andersen, Esch-Sur-Alzette (LU)

(73) Assignee: MICROSOFT CORPORATION, Redmond, WA (US)

(21) Appl. No.: 13/666,683

(22) Filed: Nov. 1, 2012

(51) Int. Cl. H04N 7/26

(52) U.S. Cl. CPC H04N 19/00569; H04N 19/00781
USPC 348/14.01; 375/240.14

(57) ABSTRACT

An encoding system comprises: an input for receiving a video signal comprising a plurality of frames each comprising a plurality of higher resolution samples; and a projection generator configured, for each respective one of the frames, to generate multiple different projections of the respective frame. Each projection comprises a plurality of lower resolution samples representing the respective frame at a lower resolution, wherein the lower resolution samples of the different projections represent different but overlapping groups of the higher resolution samples of the respective frame. The encoding system comprises an encoder configured to encode the video signal by encoding the projections of each of the respective frames.

### BACKGROUND

In the past, the technique known as “super resolution” has been used in satellite imaging to boost the resolution of the captured image beyond the intrinsic resolution of the image capture element. This can be achieved if the satellite (or some component of it) moves by an amount corresponding to a fraction of a pixel, so as to capture samples that overlap spatially. In the region of overlap, a higher resolution sample can be generated by extrapolating between the values of the two or more lower resolution samples that overlap that region, e.g. by taking an average. The higher resolution sample size is that of the overlapping region, and the value of the higher resolution sample is the extrapolated value.

The idea is illustrated schematically in FIG. 1. Consider the case of a satellite having a single square pixel P which captures a sample from an area of 1 km by 1 km on the ground. If the satellite then moves such that the area captured by the pixel shifts half a kilometre in a direction parallel to one of the edges of the pixel P, and then takes another sample, the satellite then has available two samples covering the overlapping region P′ of width 0.5 km. As this process progresses with samples being taken at 0.5 km intervals in the direction of the shift, and potentially also performing successive sweeps offset by half a pixel perpendicular to the original shift, it is possible to build up an image of resolution 0.5 km by 0.5 km, rather than 1 km by 1 km. It will be appreciated this example is given for illustrative purposes—it is also possible to build up a much finer resolution and to do so from more complex patterns of motion.

More recently the concept of super resolution has been proposed for use in video coding. There are two potential applications of this. The first is similar to the scenario described above—if the user's camera physically shifts between frames by an amount corresponding to a non-integer number of pixels (e.g. because it is a handheld camera), and this motion can be detected (e.g. using a motion estimation algorithm), then it is possible to create an image with a higher resolution than the intrinsic resolution of the camera's image capture element by extrapolating between pixel samples where the pixels of the two frames partially overlap.

The second potential application is to deliberately lower the resolution of each frame and introduce an artificial shift between frames (as opposed to a shift due to actual motion of the camera). This enables the bit rate per frame to be lowered. Referring to FIG. 2, say the camera captures pixels P′ of a certain higher resolution (possibly after an initial quantization stage). Encoding at that resolution in every frame F would incur a certain bitrate. In a first frame F(t) at some time t, the encoder therefore creates a lower resolution version of the frame having pixels of size P, and transmits and encodes these at the lower resolution. For example in FIG. 2 each lower resolution pixel is created by averaging the values of four higher resolution pixels. In the subsequent frame F(t+1), the encoder does the same but with the raster shifted by a fraction of one of the lower resolution pixels, e.g. half a pixel in the horizontal and vertical directions in the example shown. At the decoder, a higher resolution pixel size P′ can then be recreated again by extrapolating between the overlapping regions of the lower resolution samples of the two frames. More complex shift patterns are also possible. For example the pattern may begin at a first position in a first frame, then shift the raster horizontally by half a (lower resolution) pixel in a second frame, then shift the raster in the vertical direction by half a pixel in a third frame, then back by half a pixel in the horizontal direction in a fourth frame, then back in the vertical direction to repeat the cycle from the first position. In this case there are four samples available to extrapolate between at the decoder for each higher resolution pixel to be reconstructed.

### SUMMARY

Embodiments of the present invention receive as an input a video signal comprising a plurality of frames, each comprising a plurality of higher resolution samples. For each respective one of the frames, multiple different projections of the respective frame are generated. Each projection comprises a plurality of lower resolution samples representing the respective frame at a lower resolution, wherein the lower resolution samples of the different projections represent different but overlapping groups of the higher resolution samples of the respective frame. The video signal is encoded by encoding the projections of each of the respective frames.

Further embodiments of the present invention receive a video signal comprising a plurality of frames, each frame comprising multiple different projections wherein each projection comprises a plurality of lower resolution samples. The lower resolution samples of the different projections represent different but overlapping portions of the respective frame. The video signal is decoded by decoding the projections of each of the respective frames. Higher resolution samples are generated representing each of the respective frames at a higher resolution. This is done by, for each higher resolution sample thus generated, forming the higher resolution sample from a region of overlap between ones of the lower resolution samples from the different projections of the respective frame. The video signal is output to a screen at the higher resolution following generation from the projection.

Various embodiments may be embodied as an encoding system, decoding system, or computer program code to be run at the encoder or decoder side, or may be practiced as a method. The computer program may be embodied on a computer-readable medium. The computer-readable may be a tangible, computer-readable storage medium.

### BRIEF DESCRIPTION OF THE DRAWINGS

For a better understanding of the various embodiments and to show how they may be put into effect, reference is made by way of example to the accompanying drawings in which:

FIG. 1 is a schematic representation of a super resolution scheme,

FIG. 2 is another schematic representation of a super resolution scheme,

FIG. 3 is a schematic block diagram of a communication system,

FIG. 4 is a schematic block diagram of an encoder,

FIG. 5 is a schematic block diagram of a decoder,

FIG. 6 is a schematic representation of an encoding system,

FIG. 7 is a schematic representation of a decoding system,

FIG. 8 is a schematic representation of an encoded video signal comprising a plurality of streams,

FIG. 9 is a schematic representation of a video signal to be encoded,

FIG. 10 is another schematic representation of a video signal to be encoded, and

FIG. 11 is a schematic representation of the addition of a motion vector with a super resolution shift.

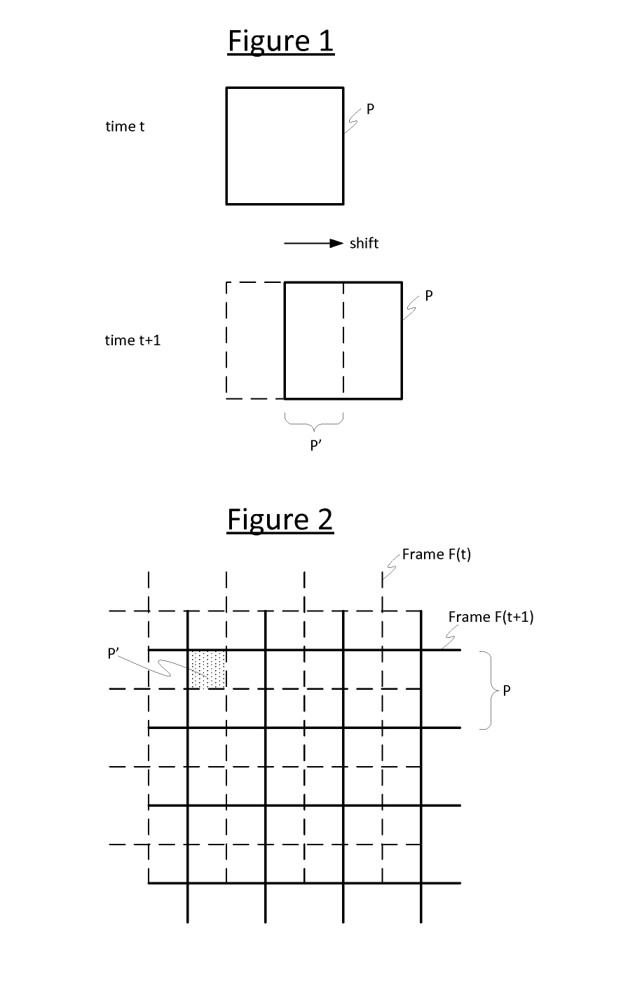

### DETAILED DESCRIPTION

The original use of super resolution was to artificially boost the resolution of a captured imaged beyond the intrinsic resolution of the capturing apparatus. As discussed, the idea was later proposed for use in video transmission to deliberately reduce resolution per frame, thereby reducing bitrate.

Embodiments of the present invention are not focused on either of these uses, but rather find a third application for the super resolution technique: namely, to divide a given frame into a plurality of different lower resolution “projections” from which a higher resolution version of the frame can be reconstructed. Each projection is a version the same frame with a lower resolution than the original frame. The lower resolution samples of each different projection of the same frame have different spatial alignments relative to one another within the frame, so that the lower resolution samples of the different projections overlap but are not coincident. For example each projection is based on the same raster grid defining the size and shape of the lower resolution samples, but with the raster being applied with a different offset or “shift” in each of the different projections, the shift being a fraction of the lower resolution sample size in either the horizontal and/or vertical direction relative to the raster orientation.

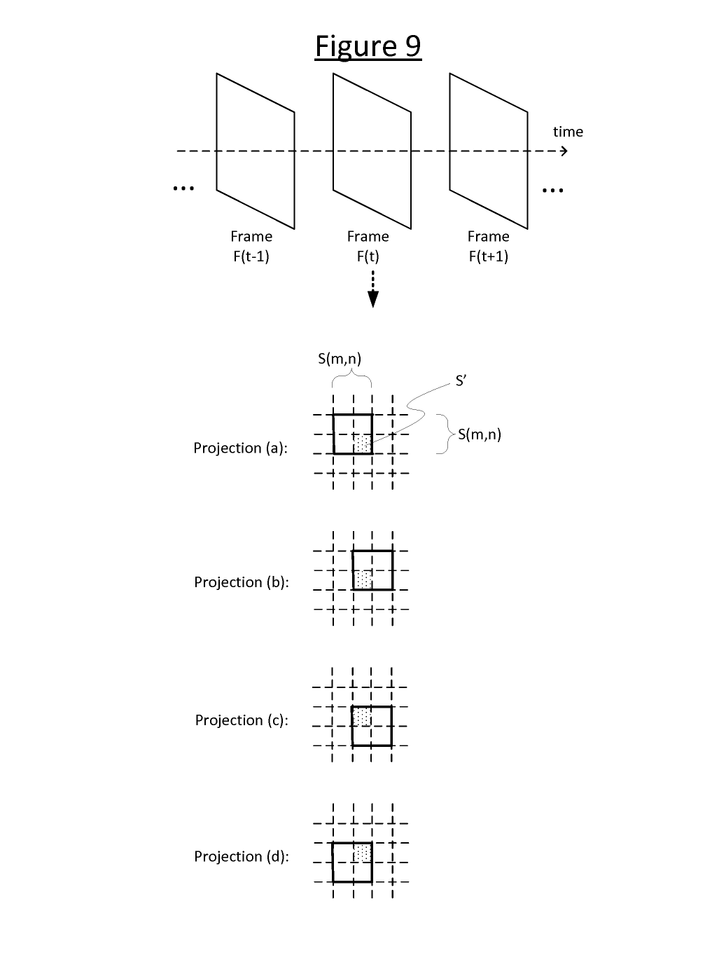

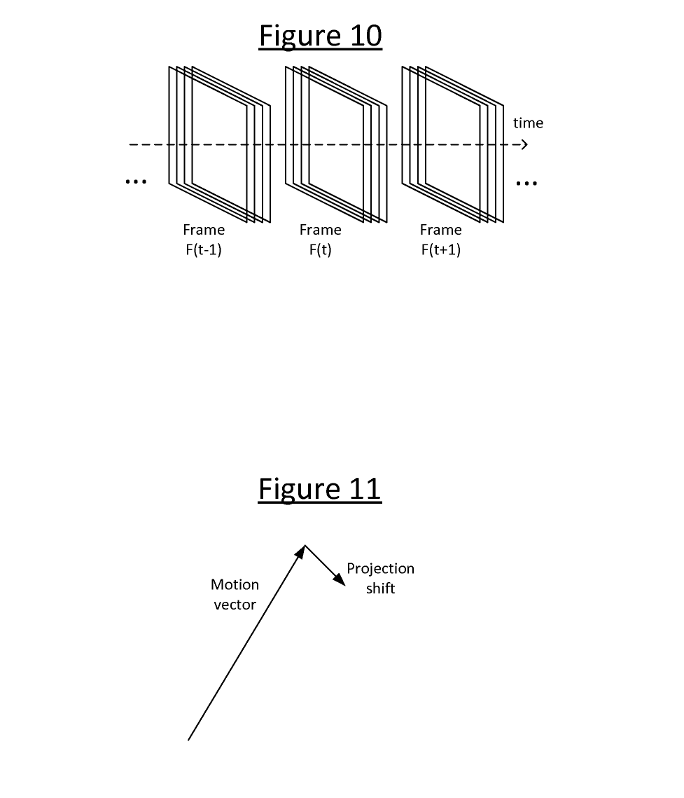

An example is shown schematically in FIGS. 9 and 10. Illustrated at the top of the page is a video signal to be encoded, comprising a plurality of frames F each representing the video image at successive moments in time . . . t−1, t, t+1, . . . (where time is measured as a frame index and t is any arbitrary point in time).

A given frame F(t) comprises a plurality of higher resolution samples S′ defined by a higher resolution raster shown by the dotted grid lines in FIG. 9. A raster is a grid structure which when applied to a frame divides it into samples, each sample being defined by a corresponding unit of the grid. Note that a sample does not necessarily mean a sample of the same size as the physical pixels of the image capture element, nor the physical pixel size of a screen on which the video is to be output. For example, samples could be captured at an even higher resolution, and then quantized down to produce the samples S′.

The same frame F(t) is split into a plurality of different projections (a) to (d). Each of the projections of this same frame F(t) comprises a plurality of lower resolution samples S defined by applying a lower resolution raster to the frame, as illustrated by the solid lines overlaid on the higher resolution grid of in FIG. 9. Again the raster is a grid structure which when applied to a frame divides it into samples. Each lower resolution sample S represents a group of the higher resolution samples S′, with the grouping depending on the grid spacing and alignment of the lower resolution raster, each sample being defined by a corresponding unit of the grid. The grid is preferably a square or rectangular grid, lower resolution samples are preferably square or rectangular in shape (as are the higher resolution samples), though that does not necessarily have to be the case. In the example shown, each lower resolution sample S covers a respective two-by-two square of four higher resolution samples S′. Another example would be a four-by-four square of sixteen.

Each lower resolution sample S represents a respective group of higher resolution samples S′ (each lower resolution sample covers a whole number of higher resolution samples). Preferably the value of the lower resolution sample S is determined by combining the values of the higher resolution samples, most preferably by taking an average such as a mean or weighted mean (although more complex relationships are not excluded). Alternatively the value of the lower resolution could be determined by taking the value of a representative one of the higher resolution samples, or averaging a representative subset of the higher resolution values.

The grid of lower resolution samples in the first projection (a) has a certain, first alignment within the frame F(t), i.e. in the plane of the frame. For reference this may be referred to here as a shift of (0, 0). The grids of lower resolution samples formed by each further projection (b) to (d) of the same frame F(t) is then shifted by a different respective amount in the plane of the frame. For each successive projection, the shift is by a fraction of the lower resolution sample size in the horizontal or vertical direction. In the example shown, in the second projection (b) the lower resolution grid is shifted right by half a (lower resolution) sample, i.e. a shift of (+½, 0) relative to the reference position (0, 0). In the third projection (c) the lower resolution grid is shifted down by another half a sample, i.e. a shift of (0, +½) relative to the second shift or a shift of (+½, +½) relative to the reference position. In the fourth projection the lower resolution grid is shifted left by another half a sample, i.e. a shift of (−½, 0) relative to the third projection or (0, +½) relative to the reference position. Together these shifts make up a shift pattern.

In FIG. 9 this is illustrated by reference to a lower resolution sample S(m, n) of the first projection (a), where m and n are coordinate indices of the lower resolution grid in the horizontal and vertical directions respectively, taking the grid of the first projection (a) as a reference. A corresponding, shifted lower resolution sample being a sample of the second projection (b) is then located at position (m, n) within its own respective grid which corresponds to position (m+½, n) relative to the first projection. Another corresponding, shifted lower resolution sample being a sample of the third projection (c) is located at position (m, n) within the respective grid of the third projection which corresponds position (m+½, n+½) relative to the grid of the first projection. Yet another corresponding, shifted lower resolution sample being a sample of the fourth projection (d) is located at its own respective position (m, n) which corresponds to position (m, n+½) of the first projection.

Note that the different projections do not necessarily need to be generated in any particular order, and any could be considered the “reference position”. Other ways of describing the same pattern may be equivalent. Other patterns are also possible, e.g. based on a lower resolution sample size of 4×4 higher resolution samples being shifted in a pattern of quarter sample shifts (a quarter of the lower resolution sample size).

The value of the lower resolution sample in each projection is taken by combining the values of the higher resolution samples covered by that lower resolution sample, i.e. by combining the values of the respective group of lower resolution samples which that higher resolution sample represents. This is done for each lower resolution sample of each projection based on the respective groups, thereby generating a plurality of different reduced-resolution versions of the same frame. The process is also repeated for multiple frames.

The effect is that each two dimensional frame now effectively becomes a three dimensional “slab” or cuboid, as shown schematically in FIG. 10.

The projections of each frame are encoded and sent to a decoder in an encoded video signal, e.g. being transmitted over a packet-based network such as the Internet. Alternatively the encoded video signal may be stored for decoding later by a decoder.

At the decoder, each of the projections of the same frame can then be used reconstruct a higher resolution sample size from the overlapping regions of the lower resolution samples. For example, in the embodiment described in relation to FIG. 9, any group of four overlapping samples from the different projections defines a unique intersection. The shaded region S′ in FIG. 9 corresponds to the intersection of the lower resolution samples S(m, n) from projections (a), (b), (c) and (d). The value of the higher resolution sample corresponding to this overlap or intersection can be found by extrapolating between the values of the lower resolution samples that overlap at the region in question, e.g. by taking an average such as a mean or weighted mean. Each of the other higher resolution samples can be found from a similar intersection of lower resolution samples.

Each frame is preferably subdivided into a full set of projections, e.g. when the shift is half a sample each frame is represented in four projections, and in the case of a quarter shift into sixteen projections. Therefore overall, the frame including all its projections together may still represent the same resolution as if the super resolution technique was not applied.

However, unlike a conventional video coding scheme the frame is broken down into separate descriptions or sub-frames, which can be manipulated separately or differently. There are a number of uses for this, for example as follows.
It provides new opportunities for prediction coding, by predicting between projections of the same frame so as to encode one or more of the projections of the frame relative to another, base one of the projections of that frame.
To enhance robustness, different projections could be used as a base projection.
The selection of base projection may be determined so as to optimize a property of the stream, e.g. to reduce the residual (preferably minimize it) so as to reduce the bitrate in the encoded signal.
As each frame becomes a three dimensional object, a three dimensional transform can be performed on each frame as part of the encoding (e.g. Fourier transform, discrete cosine transform or Karhunen-Loève transform). This may provide new opportunities to find coefficients in the transform domain that quantize to zero or to small values, thereby reducing bitrate in the encoded signal.
There is provided a new opportunity for scaling by omitting or dropping one or more projections, i.e. a new form of layered coding.
Each projection may be encoded separately as an individual stream.
Each projection may be sent as a separate stream over the network.
In the case of predictions between the projections, the base projection (which is used for predicting the other projections) may be tagged as a high priority. This may help the network layer in determining when to drop the rest of the projections and reconstruct the frame from the base layer only.

Note also that, in embodiments, the multiple projections are created by a predetermined shift pattern, not signalled over the network from the encoder to the decoder and not included in the encoded bitstream. The order of the projection may determine the shift position in combination with the shift pattern.

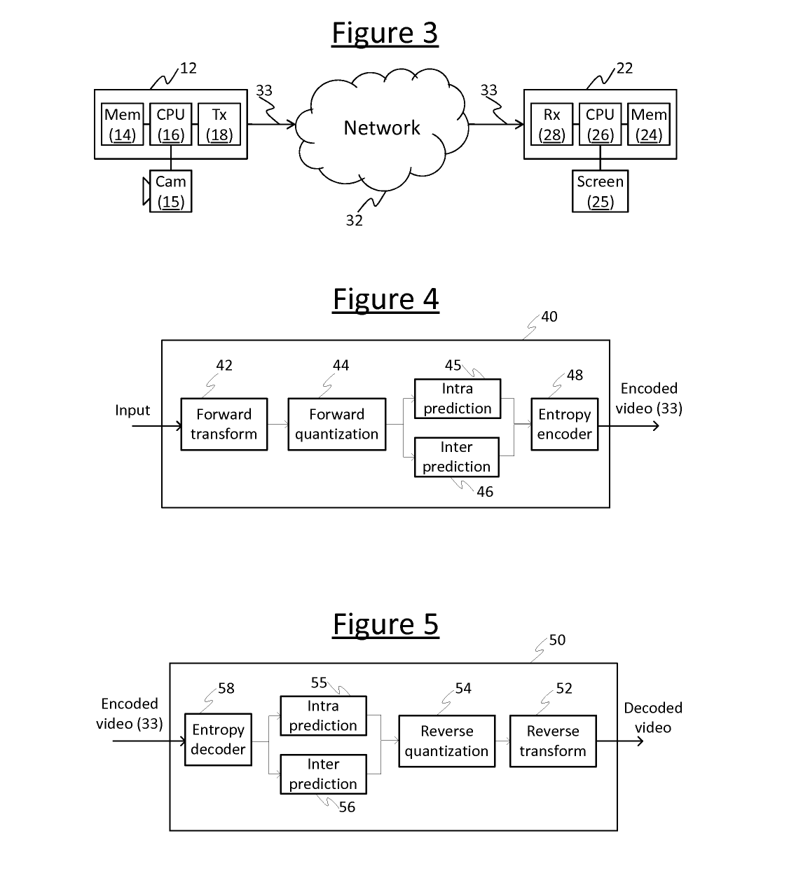

An example communication system in which the various embodiments may be employed is described with reference to the schematic block diagram of FIG. 3.

The communication system comprises a first, transmitting terminal 12 and a second, receiving terminal 22. For example, each terminal 12, 22 may comprise one of a mobile phone or smart phone, tablet, laptop computer, desktop computer, or other household appliance such as a television set, set-top box, stereo system, etc. The first and second terminals 12, 22 are each operatively coupled to a communication network 32 and the first, transmitting terminal 12 is thereby arranged to transmit signals which will be received by the second, receiving terminal 22. Of course the transmitting terminal 12 may also be capable of receiving signals from the receiving terminal 22 and vice versa, but for the purpose of discussion the transmission is described herein from the perspective of the first terminal 12 and the reception is described from the perspective of the second terminal 22. The communication network 32 may comprise for example a packet-based network such as a wide area internet and/or local area network, and/or a mobile cellular network.

The first terminal 12 comprises a tangible, computer-readable storage medium 14 such as a flash memory or other electronic memory, a magnetic storage device, and/or an optical storage device. The first terminal 12 also comprises a processing apparatus 16 in the form of a processor or CPU having one or more cores; a transceiver such as a wired or wireless modem having at least a transmitter 18; and a video camera 15 which may or may not be housed within the same casing as the rest of the terminal 12. The storage medium 14, video camera 15 and transmitter 18 are each operatively coupled to the processing apparatus 16, and the transmitter 18 is operatively coupled to the network 32 via a wired or wireless link. Similarly, the second terminal 22 comprises a tangible, computer-readable storage medium 24 such as an electronic, magnetic, and/or an optical storage device; and a processing apparatus 26 in the form of a CPU having one or more cores. The second terminal comprises a transceiver such as a wired or wireless modem having at least a receiver 28; and a screen 25 which may or may not be housed within the same casing as the rest of the terminal 22. The storage medium 24, screen 25 and receiver 28 of the second terminal are each operatively coupled to the respective processing apparatus 26, and the receiver 28 is operatively coupled to the network 32 via a wired or wireless link.

The storage medium 14 on the first terminal 12 stores at least a video encoder arranged to be executed on the processing apparatus 16. When executed the encoder receives a “raw” (unencoded) input video signal from the video camera 15, encodes the video signal so as to compress it into a lower bitrate stream, and outputs the encoded video for transmission via the transmitter 18 and communication network 32 to the receiver 28 of the second terminal 22. The storage medium on the second terminal 22 stores at least a video decoder arranged to be executed on its own processing apparatus 26. When executed the decoder receives the encoded video signal from the receiver 28 and decodes it for output to the screen 25. A generic term that may be used to refer to an encoder and/or decoder is a codec.

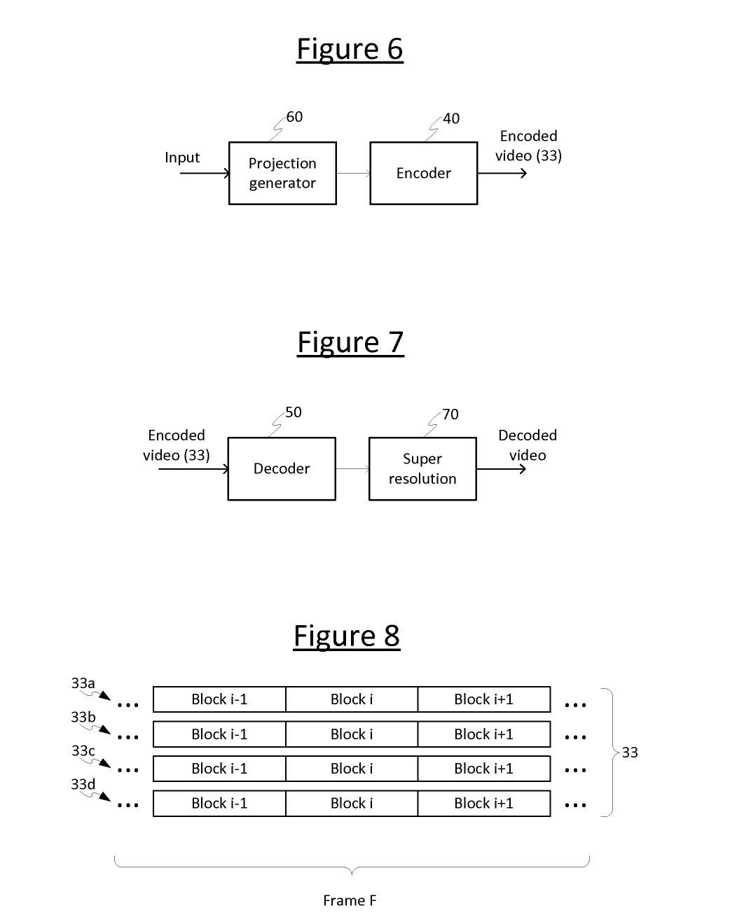

FIG. 6 gives a schematic block diagram of an encoding system that may be stored and run on the transmitting terminal 12. The encoding system comprises a projection generator 60 and an encoder 40, preferably being implemented as modules of software (though the option of some or all of the functionality being implemented in dedicated hardware circuitry is not excluded). The projection generator has an input arranged to receive an input video signal from the camera 15, comprising series of frames to be encoded as illustrated at the top of FIG. 9. The encoder 40 has an input operatively coupled to an output of the projection generator 60, and an output arranged to supply an encoded version of the video signal to the transmitter 18 for transmission over the network 32.

FIG. 4 gives a schematic block diagram of the encoder 40. The encoder 40 comprises a forward transform module 42 operatively coupled to the input from the projection generator 60, a forward transform module 44 operatively coupled to the forward transform module 42, an intra prediction coding module 45 and an inter prediction (motion prediction) coding module 46 each operatively coupled to the forward quantization module 44, and an entropy encoder 48 operatively coupled to the intra and inter prediction coding modules 45 and 46 and arranged to supply the encoded output to the transmitter 18 for transmission over the network 32.

In operation, the projection generator 60 sub-divides each frame into a plurality of projections in the manner discussed above in relation to FIGS. 9 and 10.

In embodiments, each projection may be individually passed through the encoder 40 and treated as a separate stream. For encoding each projection may be divided into a plurality of blocks (each comprising a plurality of the lower resolution samples S).

Within a given projection, the forward transform module 42 transforms each block of lower resolution samples from a spatial domain representation into a transform domain representation, typically a frequency domain representation, so as to convert the samples of the block to a set of transform domain coefficients. Examples of such transforms include a Fourier transform, a discrete cosine transform (DCT) and a Karhunen-Loève transform (KLT) details of which will be familiar to a person skilled in the art. The transformed coefficients of each block are then passed through the forward quantization module 44 where they are quantized onto discrete quantization levels (coarser levels than used to represent the coefficient values initially). The transformed, quantized blocks are then encoded through the prediction coding stage 45 or 46 and then a lossless encoding stage such as an entropy encoder 48.

The effect of the entropy encoder 48 is that it requires fewer bits to encode smaller, frequently occurring values, so the aim of the preceding stages is to represent the video signal in terms of as many small values as possible.

The purpose of the quantizer 44 is that the quantized values will be smaller and therefore require fewer bits to encode. The purpose of the transform is that, in the transform domain, there tend to be more values that quantize to zero or to small values, thereby reducing the bitrate when encoded through the subsequent stages.

The encoder may be arranged to encode in either an inter prediction coding mode or an inter prediction coding mode (i.e. motion prediction). If using inter prediction, the inter prediction module 46 encodes the transformed, quantized coefficients from a block of one frame F(t) relative to a portion of a preceding frame F(t−1). The block is said to be predicted from the preceding frame. Thus the encoder only needs to transmit a difference between the predicted version of the block and the actual block, referred to in the art as the residual, and the motion vectors. Because the residual values tend to be smaller, they require fewer bits to encode when passed through the entropy encoder 48.

The location of the portion of the preceding frame is determined by a motion vector, which is determined by the motion prediction algorithm in the inter prediction module 46. According to embodiments of the present invention in which frames are each split into a plurality of projections, the motion prediction may be between two corresponding projections from different frames, i.e. between projections having the same shift within their respective frames. For example referring to FIG. 9, blocks from projection (a) of Frame F(t) may be predicted from projection (a) of frame F(t−1), blocks from projection (b) of Frame F(t) may be predicted from projection (b) of frame F(t−1), and so forth. Alternatively a block from one projection of one frame may be predicted from a different projection having a different shift in a preceding frame, e.g. predicting a block from projection (b), (c) and/or (d) of frame F(t) from a portion of projection (a) in frame F(t−1). In the latter case, the motion vector representing the motion between frames may be added to a vector representing the shift between the different projections, in order to obtain the correct prediction. This is illustrated schematically in FIG. 11.

If using inter prediction, the transformed, quantized samples are subject instead to the intra prediction module 45. In this case the transformed, quantized coefficients from a block of the current frame F(t) are encoded relative to a block within the same frame, typically a neighbouring block. The encoder then only needs to transmit the residual difference between the predicted version of the block and the neighbouring block. Again, because the residual values tend to be smaller they require fewer bits to encode when passed through the entropy encoder 48.

In embodiments of the present invention, the intra prediction module 45 may have a special function of predicting between blocks from different projections of the same frame. That is, a block from one or more of the projections is encoded relative to a corresponding block in a base one of the projections. For example each lower resolution sample in one or more of the projections may be predicted from its counterpart sample in the base projection, e.g. so that the lower resolution sample S(m, n) in projection (b), (c) and (d) are each predicted from the sample S(m, n) in the first projection (a) and similarly for the other samples of each block. Thus the encoder only need to encode all but one of the projections in terms of a residual relative to the base projection.

This may present more opportunities for reducing the size of the residual, because corresponding counterpart samples from the different projections will tend to be similar and therefore result in a small residual. In embodiments the intra prediction module 45 may be configured to select which of the projections to use as the base projection and which to encode relative to the base projection. E.g. so the intra prediction module could instead choose projection (c) as the base projection and then encode projections (a), (b) and (d) relative to projection (c). The intra prediction module 45 may be configured to select which is the base projection in order to minimize or at least reduce the residual, e.g. by trying all or a subset of possibilities and selecting that which results in the smallest overall residual bitrate to encode.

Once encoded by the intra prediction coding module 45 or inter prediction coding module 46, the blocks of samples of the different projections are passed to the entropy encoder 48 where they are subject to a further, lossless encoding stage. The encoded video output by the entropy encoder 48 is then passed to the transmitter 18, which transmits the encoded video in one or more streams 33 to the receiver 28 of the receiving terminal 22 over the network 32, preferably a packet-based network such as the Internet.

FIG. 7 gives a schematic block diagram of a decoding system that may be stored and run on the receiving terminal 22. The decoding system comprises a decoder 50 and a super resolution module 70, preferably being implemented as modules of software (though the option of some or all of the functionality being implemented in dedicated hardware circuitry is not excluded). The decoder 50 has an input arranged to receive the encoded video from the receiver 28, and an output operatively coupled to the input of a super resolution module 70. The super resolution module 70 has an output arranged to supply decoded video to the screen 25.

FIG. 5 gives a schematic block diagram of the decoder 50. The decoder 50 comprises an entropy decoder 58, and intra prediction decoding module 55 and an inter prediction (motion prediction) decoding module 54, a reverse quantization module 54 and a reverse transform module 52. The entropy decoder 58 is operatively coupled to the input from the receiver 28. Each of the intra prediction decoding module 55 and inter prediction decoding module 56 is operatively coupled to the entropy decoder 58. The reverse quantization module 54 is operatively coupled to the intra and inter prediction decoding modules 55 and 56, and the reverse transform module 52 is operatively coupled to the reverse quantization module 54. The reverse transform module is operatively coupled to supply the output to the super resolution module 70.

In operation, each projection may be individually passed through the decoder 50 and treated as a separate stream.

The entropy decoder 58 performs a lossless decoding operation on each projection of the encoded video signal 33 in accordance with entropy coding techniques, and passes the resulting output to either the intra prediction decoding module 55 or the inter prediction decoding module 56 for further decoding, depending on whether intra prediction or inter prediction (motion prediction) was used in the encoding.

If inter prediction was used, the inter prediction module 56 uses the motion vector received in the encoded signal to predict a block from one frame based on a portion of a preceding frame. As discussed, this prediction could be between the same projection in different frames, or between different projections of different frames. In the latter case the motion vector and shift are added as shown in FIG. 11.

If intra prediction was used, the intra prediction module 55 predicts a block from another block in the same frame. In embodiments, this comprises predicting blocks of one projection based on blocks of another, base projection. For example referring to FIG. 9, projections (b), (c) and/or (d) may be predicted from projection (a).

The decoded projections are then passed through the reverse quantization module 54 where the quantized levels are converted onto a de-quantized scale, and the reverse transform module 52 where the de-quantized coefficients are converted from the transform domain into lower resolution samples in the spatial domain. The dequantized, reverse transformed samples are supplied on to the super resolution module 70.

The super resolution module uses the lower resolution samples from the different projections of the same frame to “stich together” a higher resolution version of the frame. As discussed, this can be achieved by taking overlapping lower resolution samples from different projections of the same frame, and generating a higher resolution sample corresponding to the region of overlap. The value of the higher resolution sample is found by extrapolating between the values of the overlapping lower resolution samples, e.g. by talking an average. E.g. see the shaded region overlapped by four lower resolution samples S from the four different projections (a) to (d) in FIG. 9. This allows a higher resolution sample S′ to be reconstructed at the decoder side.

In embodiments the process of reconstructing the frame from a plurality of projections may be lossless. For example this may be the case if each lower resolution sample represents four higher resolution samples of the original input frame as shown in FIG. 9, and four projections are created e.g. with shifts of (0,0); (0, +½); (+½, +½); and (+½, 0) respectively. This means a unique combination of four lower resolution samples from four different projections will be available at the decoder for every higher resolution sample to be recreated. In this case the higher resolution sample size reconstructed at the decoder side may be the same as the higher resolution sample size of the original input frame at the encoder side.

In other embodiments, the process may involve some degradation, and the higher resolution samples reconstructed at the decoder side need not be as high as the higher resolution sample size of the original input frame at the encoder side. For example this may be the case if each lower resolution sample represents four higher resolution samples of the original input frame, but only two projections are created e.g. with shifts of (0,0) and (+½, +½). In this case some information is lost in the process. However, the loss may be considered tolerable perceptually.

This process is performed for each a sequence of frames in the video signal being decoded. The reconstructed, higher resolution frames output for supply to the screen 25 so that the video is displayed to the user of the receiving terminal 22.

In one embodiment the different projections are transmitted over the network 32 from the transmitting terminal 12 to the receiving terminal 22 in separate packet streams. Thus each projection is transmitted in a separate set of packets making up the respective stream, preferably distinguished by a separate stream identifier for each stream included in the packets of that stream.

FIG. 8 gives a schematic representation of an encoded video signal 33 as would be transmitted from the encoder running on the transmitting terminal 12 to the decoder running on the receiving terminal 22. The encoded video signal 33 comprises a plurality of encoded, quantized samples for each block. Further, the encoded video signal is divided into separate streams 33a, 33b, 33c and 33d carrying the different projections (a), (b), (c), (d) respectively. In one application, the encoded video signal may be transmitted as part of a live (real-time) video phone call such as a VoIP call between the transmitting and receiving terminals 12, 22 (VoIP calls can also include video).

A result of transmitting in different streams is that one or more of the streams can be dropped, and it is still possible to decode at least a lower resolution version of the video from one of the projections, or potentially a higher (but not full) resolution version from a subset of remaining projections.

Projections may be dropped by the transmitting terminal 12 in response to feedback from the receiving terminal 22 or from the network 32 that there are insufficient resources at the receiving terminal or network conditions are inadequate to handle a full or higher resolution version of the video, or that a full or higher resolution is not required by the receiving terminal, or indeed if the transmitting terminal does not have enough resources to encode at a full or higher resolution. Alternatively or additionally, one or more of the streams carrying the different projections may be dropped by an intermediate element of the network 32 such as a router or intermediate server, in response to network conditions or information from the receiving terminal that there are insufficient resources to handle a full or higher resolution or that such resolution is not required.

For example, say a given frame is split into four projections (a) to (d) at the encoder side, each in a separate stream. If the receiving terminal 22 receives all four streams, the decoding system can recreate a full resolution version of that frame. If however one or more streams are dropped, e.g. the streams carrying projections (b) and (d), the decoding system can still reconstruct a higher (but not full) resolution version of the frame by extrapolating only between overlapping samples of the projections (a) and (c) from the remaining streams. Alternatively if only one stream remains, e.g. carrying projection (a), this can be used alone to display only a lower resolution version of the frame. Thus there may be provided a new form of layered or scaled coding based on splitting frames into different projections.

If prediction between projections is used then the base projection will not be dropped if it can be avoided, but one, some or all of the other projections predicted from the base projection may be dropped. To this end, the base projection is preferably marked as a priority by including a tag as side information in the encoded stream of the base projection. Elements of the networks 32 such as routers or servers may then be configured to read the tag (or note the absence of it) to determine which streams can be dropped and which should not be dropped if possible (i.e. dropping the higher priority base stream should be avoided).

In some embodiments a hierarchical prediction could be used, whereby one projecting is predicted from the base projection of the same frame, then one or more further projections are predicted in turn from each previously predicted projection of the same frame. E.g. so a second projection (b) may be predicted from a first projection (a), and a third projection (c) may be predicted from the second projection (b), and in turn a fourth projection (d) may be predicted from the projection (c). Further levels may be included if there are more than four projections. Each projection may be tagged with a respective priority corresponding to its order in the prediction hierarchy, and any dropping of projections or the streams carrying the projections may be performed in dependence on this hierarchical tag.

In embodiments the encoder uses a predetermined shift pattern that is assumed by both the encoder side and decoder side without having to be signalled between them, over the network, e.g. both being pre-programmed to use a pattern such as (0,0); (0, +½); (+½, +½); (+½, 0) as described above in relation to FIG. 9. In this case it is not necessary to signal the shift pattern to the decoder side in the encoded stream or streams. Accordingly, there is no concern that a packet or stream containing the indication of a shift might be lost or dropped, which would otherwise cause a breakdown in the reconstruction scheme at the decoder.

Alternatively if the encoding system is configured to select which to use as a base projection, it may be that an indication concerning the shift pattern is included in the encoded signal. If any required indication is lost in transmission, the decoding system may be configured to use a default one of the projections alone so at least to be able to display a lower resolution version.

In further embodiments of the present invention the transform module 42 may be configured to exploit the different projections of the different frames in order to perform a three dimensional transform rather than two dimensional. As mentioned in relation to FIG. 10, by generating different projections each frame now effectively becomes a three dimensional object. For example if each block to be transformed is four by four lower resolution samples, and there are four projections, then a 4×4 block of dimensions (x, y) in the plane of the frame can now be considered as a 4×4×4 cube of dimensions (x, y, z) where z is the projection number. Other sizes of block in the plane of the frame (x, y) and other depths of projection z are also possible, as are different proportions of the block in the x, y and z directions, e.g. 8×8×4, 4×8×4, 16×16×8, etc. The sample values of the different x, y and z coordinates can then be input into a three dimensional transform function such as a three dimensional Fourier transform, DCT transform or KLT transform to transform the block from a three dimensional set of sample values into a three dimensional set of coefficients in the transform domain, e.g. frequency domain. The reverse transform module 52 will be configured to perform the reverse three dimensional transform.

As mentioned the purpose of performing a transform prior to quantization is that, in the transform domain, there tend to be more values that quantize to zero or to small values, thereby reducing the bitrate when encoded through the subsequent stages including the entropy encoding stage or the like. By arranging a frame into different offset projections and thereby enabling a three dimensional transform to be performed, there may be provided more instances where transformed coefficients quantize to zero or to smaller or more similar values for more efficient encoding by the entropy encoder 58.

A three dimensional transform explores redundancies between the coefficients of multiple two dimensional transformed regions that are created with multiple views. By selecting the views, as described herein, several representations or views of the same part of the frame can be generated. For natural images this preserves high local correlation between the pixels or samples. This high correlation is now presented in three dimensions instead of two and allows for more opportunities of quantizing transform coefficients which will result in more zero or small values.

It will be appreciated that the above embodiments have been described only by way of example.

For instance, the various embodiments are not limited to lower resolutions samples formed from 2×2 or 4×4 samples corresponding samples nor any particular number, nor to square or rectangular samples nor any particular shape of sample. The grid structure used to form the lower resolution samples is not limited to being a square or rectangular grid, and other forms of grid are possible. Nor need the grid structure define uniformly sized or shaped samples. As long as there is an overlap between two or more lower resolution samples from two or more different projections, a higher resolution sample can be found from an intersection of lower resolution samples.

The various embodiments can be implemented as an intrinsic part of an encoder or decoder, e.g. incorporated as an update to an H.264 or H.265 standard, or as a pre-processing and post-processing stage, e.g. as an add-on to an H.264 or H.265 standard. Further, the various embodiments are not limited to VoIP communications or communications over any particular kind of network, but could be used in any network capable of communicating digital data, or in a system for storing encoded data on a storage medium.

Other variants may be apparent to a person skilled in the art given the disclosure herein. The present various embodiments are not limited by the described examples but only by the accompanying claims.

1. An encoding system comprising:
an input for receiving a video signal comprising a plurality of frames each comprising a plurality of higher resolution samples;
a projection generator configured, for each respective one of the frames, to generate multiple different projections of the respective frame, each projection comprising a plurality of lower resolution samples representing the respective frame at a lower resolution, wherein the lower resolution samples of the different projections represent different but overlapping groups of the higher resolution samples of the respective frame; and
an encoder configured to encode the video signal by encoding the projections of each of the respective frames.

2. The encoding system of claim 1, wherein the lower resolution samples are defined by a grid structure, and the projection generator is configured to generate the projections by applying one or more different spatial shifts to the grid structure within the respective frame, each shift being by a fraction of one of the lower resolution samples.

3. The encoding system of claim 2, wherein the projection generator is configured to apply the shifts according to a predetermined shift pattern.

4. The encoding system of claim 1, wherein the encoder is configured to encode the video signal by applying prediction coding between different ones of the projections, whereby each of one or more of the projections is encoded relative to another one of said projections.

5. The encoding system of claim 4, wherein the encoder is configured to encode one or more of the respective frames by applying prediction coding between the projections of the respective frame, whereby each of one or more of the projections of the respective frame is encoded relative to another, base one of the projections of the respective frame.

6. The encoding system of claim 5, comprising a transmitter configured to transmit the video signal over a network following encoding, wherein the different projections are transmitted in separate streams.

7. The encoding system of claim 6, wherein the encoding system is configured to tag the stream carrying the base projection as a priority.

8. The encoding system of 5, wherein the encoder is configured to select which is the base projection based on an optimization criterion.

9. The encoding system of claim 8, wherein the encoder is configured to select which is the base projection by selecting that which reduces a residual of the prediction coding relative to others of the projections of the respective frame.

10. The encoding system of claim 1, comprising a transform module configured to perform a three dimensional transform transforming each of the respective frames into a transform domain representation, wherein the transform is performed in two dimensions in a plane of the respective frame and a third dimension created by said multiple projections of the respective frame.

11. The encoding system of claim 10, wherein the transform domain representation is a frequency domain representation.

12. The encoding system of claim 2, wherein the lower resolution samples within each projection have a uniform size and shape defined by said grid.

13. The encoding system of claim 1, wherein the lower resolution samples are generated by averaging the groups of the higher resolution samples.

14. The encoding system of claim 1, comprising a transmitter configured to transmit the video signal over a packet-based network following encoding.

15. The encoding system of claim 1, comprising a transmitter configured to transmit the video signal over a network following encoding, wherein the encoder and transmitter are arranged to encode and transmit the video signal dynamically as part of a live video call.

16. A computer program product embodied on a tangible, computer-readable storage medium and comprising code configured so as when executed on a processing apparatus to perform operations comprising:
receiving a video signal comprising a plurality of frames, each frame comprising multiple different projections wherein each projection comprises a plurality of lower resolution samples, the lower resolution samples of the different projections representing different but overlapping portions of the respective frame;
decoding the video signal by decoding the projections of each of the respective frames;
generating higher resolution samples representing each of the respective frames at a higher resolution by, for each higher resolution sample thus generated, forming the higher resolution sample from a region of overlap between ones of the lower resolution samples from the different projections of the respective frame; and
an output for outputting the video signal to a screen at the higher resolution following generation from the projections.

17. The computer program product of claim 16, wherein:
the lower resolution samples are defined by a grid structure, the different projections having been formed from one or more different spatial shifts of the grid structure within the respective frame, each shift being by a fraction of one of the lower resolution samples; and
said region of overlap used to form the higher resolution samples is determined by the one or more shifts of the grid structure.

18. The computer program product of claim 16, wherein:
the decoding comprises predicting each of one or more of the projections of the respective frame from another, base one of the projections of the respective frame.

19. The computer program product of claim 16, wherein:
the decoding comprises performing a three dimensional inverse transform transforming each of the respective frames from a transform domain representation, wherein the transform is performed in two dimensions in a plane of the respective frame and a third dimension created by said multiple projections of the respective frame.

20. A method comprising:
at a transmitting terminal, inputting a video signal comprising a plurality of frames each comprising a plurality of higher resolution samples;
at the transmitting terminal, for each respective one of the frames, generating multiple different projections of the respective frame, each projection comprising a plurality of lower resolution samples defined by a grid structure and representing the frame at lower resolution, wherein the different projections are generated by applying a different spatial shift to the grid structure within the respective frame, each shift being by a fraction of one of the lower resolution samples, thus defining a region of overlap between ones of the lower resolution samples;
at the transmitting terminal, encoding the video signal by encoding the projections of each of the respective frames;
transmitting the video signal from the transmitting terminal over a network following encoding;
at a receiving terminal, receiving and decoding the video signal by decoding the projections of each of the respective frames;
at the receiving terminal, generating higher resolution samples representing each of the respective frames at a higher resolution by, for each higher resolution sample thus generated, forming the higher resolution sample from the region of overlap between ones of the lower resolution samples from the different projections of the respective frame based on said one or more shifts of the grid structure; and
outputting the video signal to a screen at the higher resolution following generation from the projections.
